(19) United States
(12) Patent Application Publication
(10) Pub. No.: US 2008/0143780 A1
(43) Pub. Date: Jun. 19, 2008

(54) INK JET PRINTING APPARATUS

(75) Inventors: Atsushi Sakamoto, Kawasaki-shi (JP); Hidehiko Kanda, Yokohama-shi (JP); Hirokazu Tanaka, Tokyo (JP); Jiro Moriyama, Kawasaki-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/957,772

(22) Filed: Dec. 17, 2007

(30) Foreign Application Priority Data
Dec. 19, 2006 (JP) 2006-341392

(51) Int. Cl. B41J 2/165

(52) U.S. Cl. 347/32

(57) ABSTRACT

The present invention provides an ink jet printing apparatus that can print high-quality images even if a print head with smaller nozzles is used, by efficiently stabilizing the ink ejection state of the print head without increasing the running costs of the printing apparatus. A cap that can be used to cap the print head includes a hole through which ink inside the cap is discharged and which can be sealed so as to retain the ink in the cap.

### BACKGROUND OF THE INVENTION

1. Field of the Invention

The present invention relates to an ink jet printing apparatus that uses a print head that is able to eject ink, to print an image on a print medium.

2. Description of the Related Art

For ink jet printing apparatuses, to meet requirements in the market for improved image quality and increased printing speed, efforts have been made to increase the number of ink colors, the density of ink dots, and the number of nozzles in a print head, while reducing the size of ejected ink drops. Thus, users can now easily obtain images of equivalent quality with silver halide photography. Such ink jet printing apparatuses are very often used not only in the business market but also in the home market. On the other hand, in the market of ink jet printing apparatuses, it has been very necessary to reduce the costs of the printing apparatuses themselves in order to provide users with more inexpensive printing apparatuses.

Under these circumstances, in particular, for a reduction in the size of ejected ink drops, it is necessary to allow fine ink drops of several pl (picolitters) to accurately impact print sheets. Always stabilizing ink ejection (maintaining a fixed ejection amount) is thus essential.

Evaporation of moisture in ink from nozzles in the print head significantly affects ink ejection. Thus, conventional ink jet printing apparatuses adopt improved cap configurations or control for allowing ink affected by evaporation to be discharged, in order to inhibit and prevent the possible evaporation of moisture from the nozzles in the print head.

For example, in order to increase the sealing level of the cap, a configuration has been adopted in which an air communication passage formed in a rear surface of a cap covering the print head is bent to increase the total length of the passage. Japanese Patent Laid-Open No. 2002-331673 describes a configuration comprising a metal pipe provided on a bottom surface of the cap and serving as an air communication passage, the metal pipe exerting a high evaporation inhibiting effect. Japanese Patent Laid-Open No. 04-355153 describes a configuration in which a porous absorbent containing a moisture retaining component is housed in the cap to inhibit the possible evaporation of moisture from the nozzles in the print head.

If the moisture in the ink evaporates from ink ejection ports in the print head which constitute the nozzles to increase the viscosity of the ink in the vicinity of the ejection ports or to stick the ink to the vicinity of the ejection ports, the ink may not be stably ejected. Thus, the conventional ink jet printing apparatuses adopt a method of ejecting ink not contributing to printing from the ejection ports at predetermined time intervals (this method is hereinafter referred to as “preliminary ejection”). To prevent an excessive increase in ink viscosity and excessive sticking, a method has been proposed which periodically performs a suction recovery operation of introducing negative pressure generated by a negative pressure generating pump into the cap covering the print head to suck and discharge the ink into the cap through the ejection ports.

If the cap with the ink collected therein as a result of the preliminary ejection or suction recovery operation remains, for a long period, in a capping state in which the cap tightly seals the print head, the ink in the cap may flow back toward the print head to cause a problem such as the mixture of ink colors. Thus, an idle sucking operation is performed in order to suck and discharge the ink collected in the cap.

If an increase in the number of nozzles and a reduction in the size of the nozzles are carried out to allow the ink jet printing apparatus to achieve improved image quality and high speed printing, the evaporation of moisture from the ink ejection ports in the print head exerts more significant adverse effects.

However, an increase in the manufacturing costs of the ink jet printing apparatus results from any of the configuration in which the bent air communication passage is formed in the cap bottom surface, the configuration having the metal pipe, and the configuration in which the porous member is provided in the cap.

A further reduction in the size of the print head causes the evaporation of moisture from the ink ejection ports to more seriously affect ink ejection. This requires frequent cleaning control for the print head, such as the preliminary ejection or suction recovery operation. Thus, the frequent performance of the cleaning control on the print head increases the ratio of the ink used to stabilize the ink ejection to the ink used for actual printing. This increases running costs. Moreover, to stabilize the ink ejection, discharged waste ink must be held. This requires an absorbent which holds the waste ink and the volume of which increases consistently with the amount of the waste ink. As a result, the size of the printing apparatus increases.

Furthermore, inexpensive ink jet printing apparatuses without the negative pressure generating pump cannot discharge the ink in the cap to the exterior. Thus, if the cap remains in the capping state for a long period, the ink colors may be mixed.

The present invention provides an ink jet printing apparatus that can print high-quality images even if a print head with smaller nozzles is used, by efficiently stabilizing the ink ejection state of the print head without increasing the running costs of the printing apparatus.

The present invention also provides an ink jet printing apparatus that can print high-quality images by efficiently stabilizing the ink ejection state of the print head without increasing the size and costs of the printing apparatus.

### SUMMARY OF THE INVENTION

In the first aspect of the present invention, there is provided an ink jet printing apparatus printing an image using a print head that is able to eject ink from ejection ports therein and comprising a cap that is able to cap the print head in order to inhibit evaporation of moisture in the ink from the ejection ports, wherein the cap comprises: an opening through which the ink inside the cap is discharged to an exterior; and an opening and closing mechanism which is able to open and close the opening and which is able to close the opening so as to retain the ink in the cap.

According to the present invention, the cap that can cap the print head comprises an opening through which the ink inside the cap is discharged to the exterior. The opening can be sealed so as to retain the ink in the cap. This enables the cap with the ink collected therein to be fitted on the print head for capping to prevent the moisture from evaporating from the ejection ports in the print head. Consequently, even if a print head with smaller nozzles is used, the ink ejection state of the print head can be efficiently stabilized while preventing an increase in the amount of ink used. This enables high-quality images to be printed while preventing an increase in running costs.

Furthermore, the opening is formed at the position such that the ink in the cap is discharged through the opening owing to the weight of the ink. This eliminates the need for a pump or the like which discharges the ink from the cap. As a result, the ink ejection state of the print head is stabilized, allowing high-quality images to be printed while preventing an increase in the size and costs of the printing apparatus.

Further features of the present invention will become apparent from the following description of exemplary embodiments (with reference to the attached drawings).

### BRIEF DESCRIPTION OF THE DRAWINGS

FIG. 1 is a diagram of the configuration of a cap as a comparative example of the present invention;

FIG. 2 is a diagram illustrating test results for the sealing level of the cap in FIG. 1 with the print head;

FIG. 3 is a diagram illustrating check results for a variation in ink ejection state observed while the print head used for the tests in FIG. 2 is uncapped;

FIG. 4 is a diagram of test results for retention of moisture in the tested print head shown in FIG. 3;

FIG. 5 is a plan view and a sectional view showing that the cap in accordance with the embodiment of the present invention is in the state of a high sealing level;

FIG. 6 is a sectional view showing that the cap in FIG. 5 is in the state of a low sealing level;

FIG. 7 is a flowchart illustrating control for stabilizing the ink ejection state of the print head using the cap in FIG. 5;

FIG. 8 is a diagram illustrating a table used for the control shown in FIG. 7;

FIG. 9 is a diagram illustrating verification results for the performance of the cap set at the high sealing level;

FIG. 10 is a diagram illustrating verification results for the performance of the cap set at the low sealing level;

FIG. 11 is a diagram illustrating verification results for the performance of the cap set at the high sealing level as shown in FIG. 5;

FIG. 12 is a schematic perspective view of a printing apparatus to which the present invention is applicable;

FIG. 13 is a block diagram of a control system for the printing apparatus in FIG. 12;

FIG. 14A is a plan view and a sectional view showing that the cap in accordance with the other embodiment of the present invention is in the state of a high sealing level;

FIG. 14B is a sectional view showing that the cap in FIG. 14A is in the state of a low sealing level; and

FIG. 14C is a sectional view showing that the cap in FIG. 14A is in the state of a lower sealing level than that of FIG. 14B.

### DESCRIPTION OF THE EMBODIMENTS

Embodiments of the present invention will be described with reference to the drawings.

### (Example of Configuration of Ink Jet Printing Apparatus)

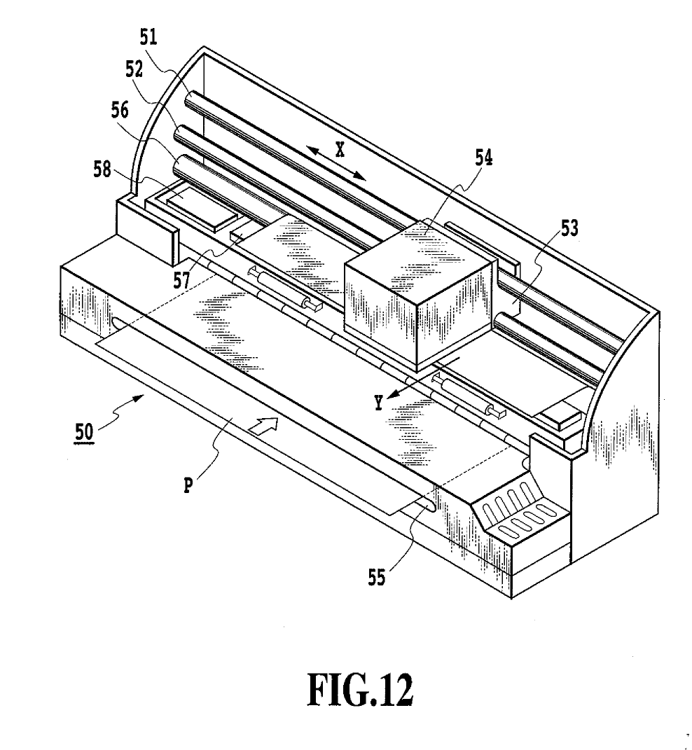

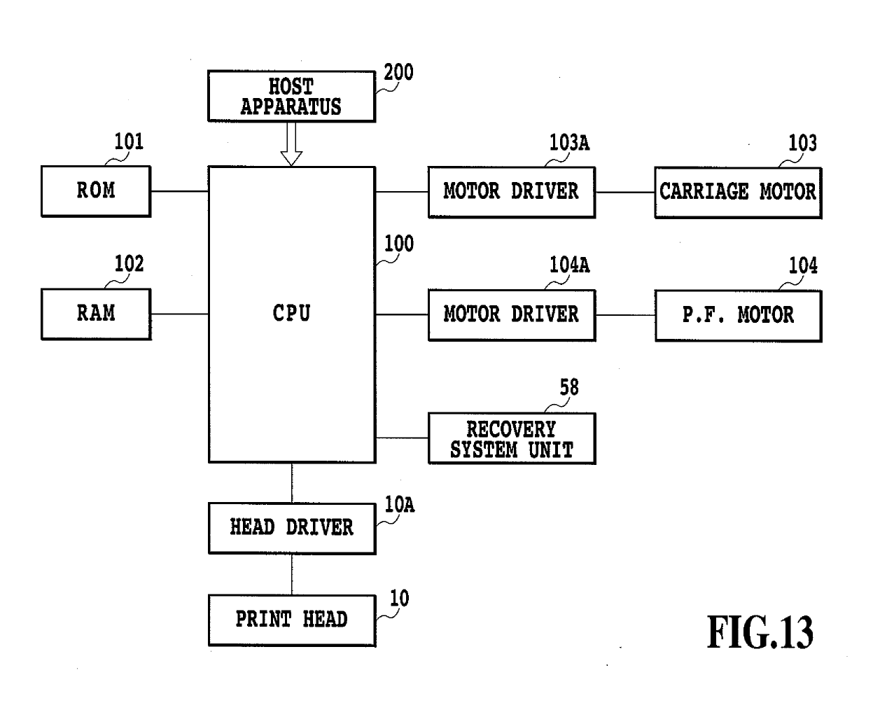

FIGS. 12 and 13 are diagrams illustrating an example of a configuration of an ink jet printing apparatus to which the present invention is applicable.

FIG. 12 is a perspective view illustrating a schematic configuration of an ink jet printing apparatus to which the present invention is applicable. An ink jet printing apparatus 50 in the present example is based on a serial scan scheme. A carriage 53 is guided by guide shafts 51 and 52 so as to be movable in a main scanning direction shown by arrow X. The carriage 53 is reciprocated in the main scanning direction by a carriage motor and a driving force transmitting mechanism such as a belt which transmits the driving force of the carriage motor. The carriage 53 has a print head (not shown) mounted thereon and an ink tank 54 also mounted thereon to supply ink to the print head. The print head and the ink tank 54 may constitute an ink jet cartridge. A sheet P as a printed medium is inserted through an insertion port 55 formed at a front end 55 of the apparatus, and a direction in which the sheet P is conveyed is reversed. The sheet is then conveyed by a feeding roller 56 in a sub-scanning direction shown by arrow Y. The sub-scanning direction X crosses the main scanning direction (in the present example, at right angles).

The print head is an ink jet print head that can eject ink from ejection ports constituting nozzles. The print head can use an electrothermal converter (heater) or a piezo element as ink ejection energy generating means. With the electrothermal converter, heat generated by the electrothermal converter bubbles the ink so that the resulting bubbling energy can be utilized to eject the ink from the ejection ports.

The printing apparatus 50 repeats a printing operation of ejecting the ink toward a print area on the sheet P on a platen 57 while moving the print head in the main scanning direction, and a conveying operation of conveying the sheet P by a distance corresponding to the print width of the sheet P. This allows images to be sequentially printed on the sheet P.

A recovery system unit (recovery processing means) 58 is provided at a left end of the area within which the carriage 53 moves as shown in FIG. 12; the recovery system unit 58 is located opposite a surface of the print head on which ejection ports are formed. The recovery system unit 58 comprises a cap and the like which can cap the ejection ports in the print head as described below. The print head can be kept in an acceptable ink ejection state by ejecting ink not contributing image printing from the ejection ports (preliminary ejection).

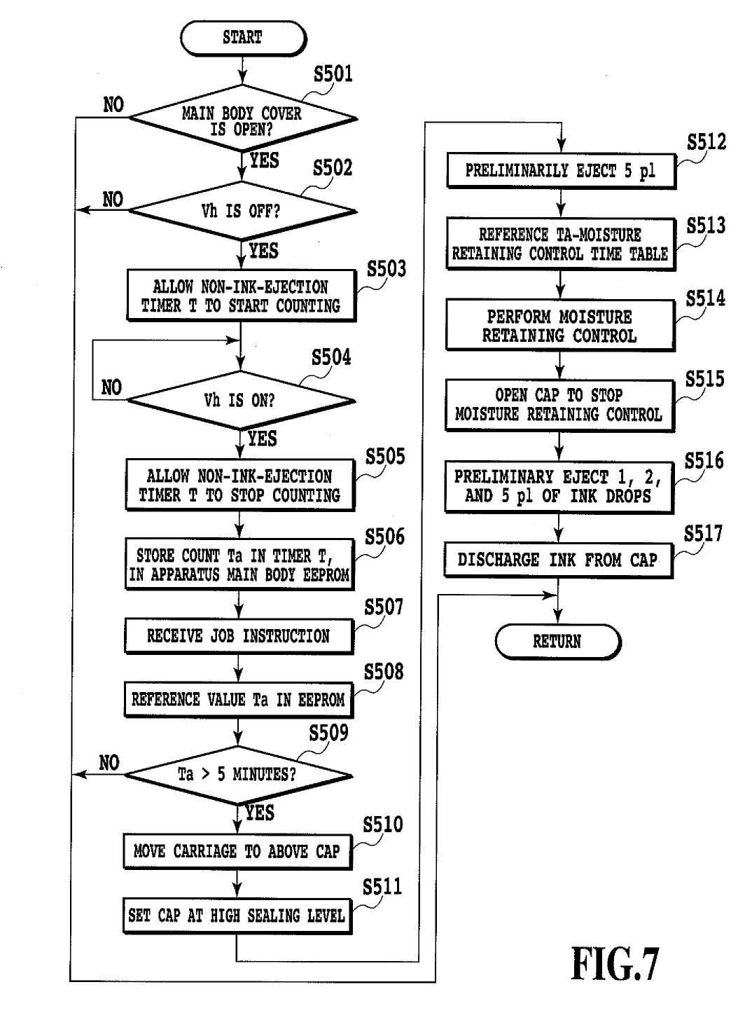

FIG. 13 is a schematic block diagram of a control system for the printing apparatus 50 in FIG. 12. In FIG. 13, a CPU 100 executes a process of controlling operations of the present printing apparatus as well as data processing. Programs for process procedures for these processes are stored in a ROM 101, and a RAM 102 is used as a work area in which the processes are executed. If the electrothermal converter is used as ink ejection energy generating means in the print head, the ejection of ink from the print head is controlled by the CPU 100 via a head driver 10A. That is, on the basis of image data input by a host apparatus 200, the CPU 100 supplies driving data (image data) for the electrothermal converter and driving control signals (heat pulse signals) to the head driver 10A. The CPU 100 controls, via a motor driver 103A, a carriage motor 103 that drives the carriage 53 in the main scanning direction, and controls, via a motor driver 104A, a P. F motor 104 that conveys the sheet P in the sub-scanning direction. The CPU 100 also performs moisture retaining control such as that shown in FIG. 7, described below.

### COMPARATIVE EXAMPLE

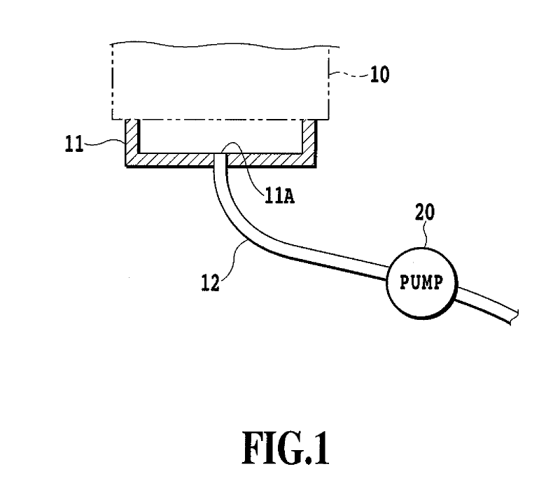

FIGS. 1 to 5 are diagrams illustrating a recovery system unit 58 comprising a negative pressure generating pump, as a comparative example of the present invention.

A cap in the recovery system unit 58 of the ink jet printing apparatus requires a high sealing level sufficient to inhibit the evaporation of moisture in the ink from the nozzles in the print head during a period when the user does not use the printing apparatus.

FIG. 1 is a schematic diagram of a cap 11 comprising a negative pressure generating pump 13. Since the cap 11 requires a high sealing level, a butyl-containing rubber material is used for the cap 11. A hole 11A from which the ink is discharged is formed in a bottom surface of the cap 11. In the present example, the hole 11A has an inner diameter of 1.0 mm and a length of 4.0 mm equal to the thickness of the bottom portion of the cap 11. A tube 12 is coupled to the hole 11A. When the cap 11 contacts a surface of the print head 10 in which the ejection ports are formed, to go into a capping state, the negative pressure generating pump 13 allows generated negative pressure to act in the cap 11 via the tube 12. The material of the cap 11 contributes significantly to the sealing level of the cap 11. The following also have effects on the sealing level: the inner diameter and length of the hole 11A, formed in the bottom portion of the cap 11, the material (gas permeable) of the tube 12, and the inner diameter, thickness, and length of the tube 12.

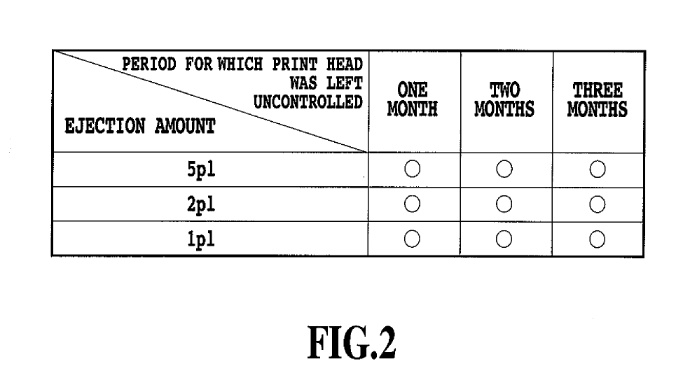

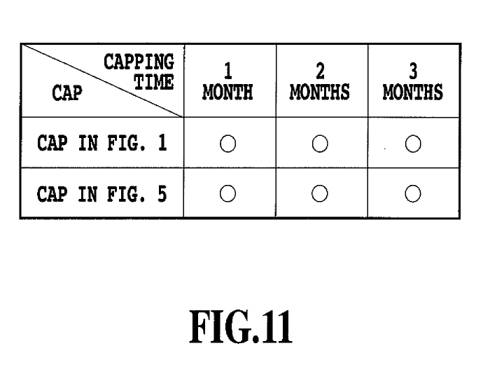

As shown in FIG. 2, three types of print heads 10 with ink ejection amounts of 5 pl, 2 pl, and 1 pl, respectively, were combined with the cap 11 in FIG. 11, and the cap 11 was checked for the functions thereof. That is, each of the print heads 10 and the cap 11 were abutted against each other and were left uncontrolled for three months under conditions including a temperature of 30° C. and a humidity of 15%. Subsequently, a preliminary ejection was carried out in which 2,000 ink droplets were ejected from the ejection ports in each print head 10, forming the nozzles. After the preliminary ejection, each print head 10 was checked for the ink ejection state. All the print heads 10 ejected an appropriate amount of ink, and none of the print heads 10 were subjected to non-ejection of the ink or the bias of the ejecting direction. Circles in FIG. 2 indicate that the non-ejection of the ink, the bias of the ejecting direction, and the like were prevented. Therefore, whichever print head is combined with the cap 11 configured as shown in FIG. 1, the cap is sufficiently effective for inhibiting the evaporation of moisture in the ink from the ejection ports; the cap has a high sealing level.

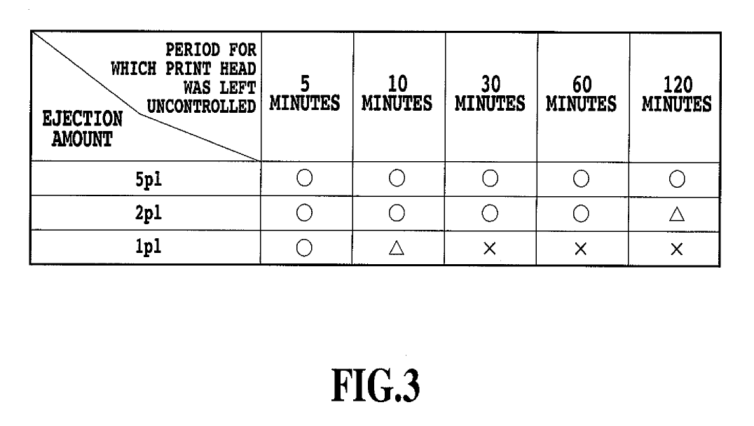

Furthermore, the three types of print heads 10 were left uncapped for 5 to 120 minutes under conditions including a temperature of 30° C. and a humidity of 15%. Subsequently, the preliminary ejection was carried out in which 500 ink droplets were ejected from the ejection ports in each print head, forming the nozzles in each print head 10. After the preliminary ejection, each print head 10 was checked for the ink ejection state. The results are shown in FIG. 3.

In FIG. 3, circles mean that the ink ejection state was stable, a triangle means that the ink ejecting direction was biased, and crosses mean that the print head went into the non-ejection state; the print head was prevented from ejecting the ink. For the print head 10 with an ink ejection amount of 5 pl, the ink ejection state was stabilized by carrying out the preliminary ejection in which 500 ink droplets were ejected after the print head 10 had been left uncontrolled for 120 minutes. However, for the print head 10 with an ink ejection amount of 1 pl, when the print head 10 was left uncontrolled for at most 5 minutes, the preliminary ejection with 500 drops stabilized the ink ejection state. However, when the print head 10 was left uncontrolled for 10 minutes, the ink ejecting direction was biased. When the print head 10 was left uncontrolled for at least 30 minutes, the print head 10 went into the non-ejection state, in which the ink failed to be ejected from most of the nozzles. For the print head 10 with an ink ejection amount of 2 pl, when the print head 10 was left uncontrolled for shorter than 120 minutes, the ink ejection state was stabilized. However, when the print head 10 was left uncontrolled for at least 120 minutes, the ink ejecting direction was biased. The non-ejection of the ink and the bias of the ejecting direction result from an increase in the viscosity of the ink in the vicinity of the ejection ports or the sticking of a color material in the ink, which is caused by the evaporation of the moisture in the ink from the ejection ports in the print head.

These experiment results indicate that a sufficient sealing level is achieved when the cap 11 in FIG. 1 covers the ejection ports in the print head 10. Furthermore, when the ejection ports in the print head 10 are not covered with the cap 11, the evaporation of the moisture in the ink from the ejection ports more seriously affects the print head 10 with a smaller ink ejection amount, which thus fails to stably eject the ink.

In the ink jet printing apparatus, this phenomenon does not occur during a printing operation. However, this phenomenon may occur when, for example, the user replaces the ink tank or removes the print head from the carriage because the ink may not be ejected from the print head and because capping may not be performed.

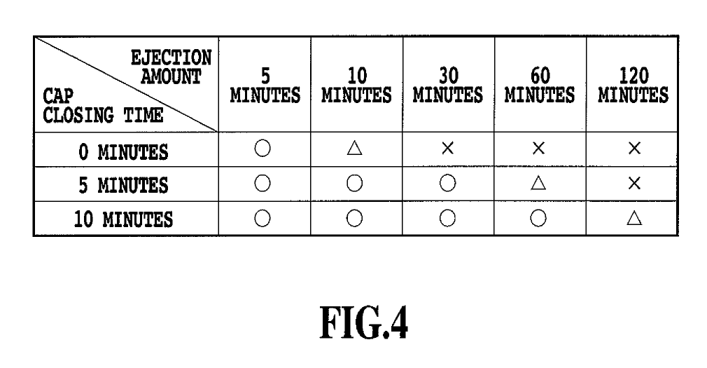

FIG. 4 shows results of tests described below and carried out on the print head 10 used in the tests in FIG. 3 and having an ink ejection amount of 1 pl, that is, the print head in which the non-ejection of the ink or the bias of the ejecting direction was caused by the evaporation of the moisture in the ink from the ejection ports in the print head 10. That is, after the tests in FIG. 3, capping (cap closing operation) was performed on the print head 10 with an ink ejection amount of 1 pl in such a manner that the cap 11 with the ink collected therein covers the ejection ports. The capping state was maintained for different periods of time (0 minute, 1 minute, and 10 minutes), and the print head was checked for the ink ejection state again. Circles, triangles, and crosses have meanings similar to those in FIG. 3.

The ink ejection state was better when the period of the capping state (cap closing time) was 1 minute than when the cap closing time was 0 minute. That is, where the cap closing time was 1 minute, the ink was normally ejected even when the print head was left uncontrolled for 30 minutes. Even when the print head was left uncontrolled for 60 minutes, the only adverse effect was the bias of the ink ejecting direction detected in several of the nozzles. Where the cap closing time was 10 minutes, the ink was normally ejected even when the print head was left uncontrolled for 60 minutes. Even when the print head was left uncontrolled for 120 minutes, the only adverse effect was the bias of the ink ejecting direction detected in several of the nozzles.

In the print head 10 with an ink ejection amount of 1 pl, which was tested, the evaporation of the moisture in the ink from the ejection ports during the tests in FIG. 3 increased the viscosity of the ink in the vicinity of the ejection ports and caused sticking of the color material in the ink, preventing stable ink ejection. In the subsequent tests in FIG. 4, as described above, the ink was preliminarily ejected into the cap 11 with a high sealing level to increase the humidity in the cap 11. The cap 11 was then used to perform the cap closing operation for a specified time. The test results indicate that the cap exerts a moisture retaining effect on the ink in the vicinity of the nozzles which had the viscosity thereof increased or which was half-stuck to the vicinity of the nozzles, thus promoting a reduction in the viscosity of the ink and re-dissolution of the ink.

Thus, collecting the ink in the cap with a high sealing level for moisture retention as described with reference to FIG. 4 is effective on the print head described with reference to FIG. 3, that is, the print head subjected to an increase in ink viscosity or ink sticking because the print head has remained uncapped for a short time.

### (Characteristic Configuration of Present Invention)

The present invention is applicable to an inexpensive ink jet printing apparatus not equipped with any pump that generates negative pressure. That is, according to the present invention, a cap with a variable sealing level as described below is provided and brought into the state of a high sealing level to inhibit the evaporation of the moisture in the ink from the print head, and the ink is preliminarily ejected into the cap to perform moisture retaining control on the print head. Moreover, the cap is brought into the state of a low sealing level to allow the ink to be discharged from the cap.

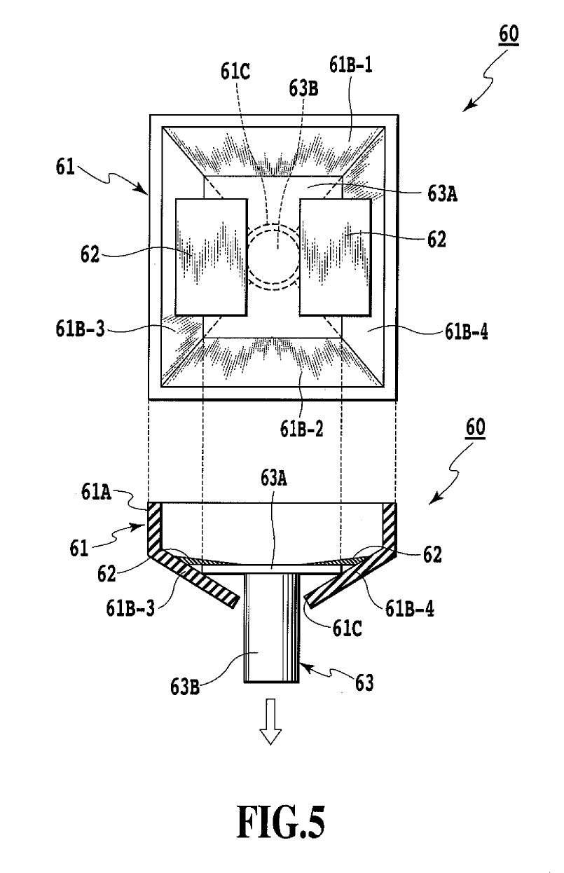

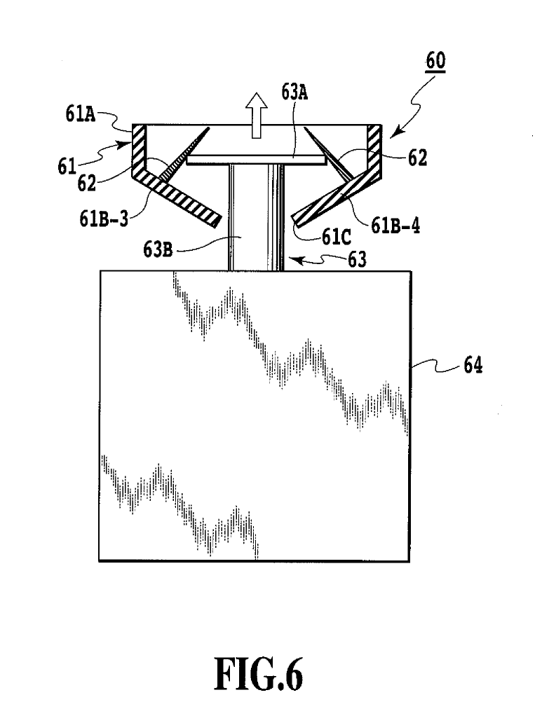

FIGS. 5 and 6 are diagrams illustrating an example of a configuration of a cap 60 provided in the recovery system unit 58 of the ink jet printing apparatus shown in FIGS. 12 and 13. FIG. 5 is a plan view and a sectional view showing that the cap 60 with the variable sealing level is in the state of the high sealing level. FIG. 6 is a sectional view showing that the cap 60 is in the state of the low sealing level.

A rubber member 61 mainly constituting the cap 60 is formed like a square planar mortar. That is, the rubber member 61 has a square planar frame-like portion 61A that can be tightly contacted with the ejection port forming surface of the print head and four incline surface portions 61B-1, 61B-2, 61B-3, and 61B-4 extending obliquely downward from the respective sides of the frame-like portion 61A. Moreover, a circular hole 61C of inner diameter 2.5 mm is formed in a bottom portion of the rubber member 61 at which the four inclined surface portions 61B-1 to 61B-4 join together, as an opening from which the ink in the cap 60 is discharged. A plastic member 63 with a T-shaped cross section is provided inside the cap 60. The plastic member 63 constitutes an opening and closing mechanism for opening and closing the hole 61C as an opening. That is, a square planar upper plate portion 63A and a columnar portion 63B are formed in the plastic member 63; the plate portion 63A functions as a valve disc, and the columnar portion 63B functions as an operation member that can operate the plate portion 63A from the outside of the cap 60. The plate portion 63A can be contacted with and separated from a peripheral surface of the hole 61C inside the cap 60. The plate portion 63A can also seal the hole 61C so as to retain the ink in the cap 60. Two of the four sides of a top surface of the plate portion 63A are pressed by two rubber members 62 provided on the respective inclined surface portions 61B-3 and 61B-4. The columnar portion 63B is formed like a column of outer diameter 2.0 mm and penetrate the hole 61A in the rubber member 61. A gap is formed between the columnar portion 63B and the hole 61A.

As shown in FIG. 5, when the plate portion 63A of the plastic member 63 is positioned in the lower part of the interior of the cap 60, the plate portion 63A is pressed downward by the rubber member 62, with bottom surface-side peripheral portions of the plate portion 63A in tight contact with top surfaces of the four incline surface portions 61B-1 to 61B-4. The hole 61C is thus sealed to increase the sealing level of the cap 60.

As shown in FIG. 6, when a lower end of the columnar portion 63B of the plastic member 63 is pressed by a waste ink absorbent 64, the plastic member 63 moves upward in the cap 60 against the pressing force of the rubber member 62. The movement of the plastic member 63 separates the bottom surface-side peripheral portions of the plate portion 63A from the top surfaces of the respective inclined surface portions 61B-1 to 61B-4. The hole 61C is thus opened to allow the inside and outside of the cap 60 to communicate with each other through the hole 61C, reducing the sealing level of the cap 60. This enables the ink collected in the cap 60 to be discharged to the outside through the hole 61C. The discharged waste ink is absorbed and held by the absorbent 64.

The cap 60 is moved relative to the print head to cap and uncap the print head. Means for moving the cap 60 and the print head relative to each other may be, for example, a mechanism for moving the carriage 53 and a mechanism for moving the cap 60 up and down with respect to the print head. The cap 60 and the absorbent 64 move relative to each other to open and close the hole 61C. Means for moving the cap 60 and the absorbent 64 relative to each other may be, for example, a mechanism for moving the cap 60 up and down relative to the print head.

FIG. 7 is a flow chart illustrating an example of the moisture retaining control.

When the user replaces the ink tank or removes the print head from the carriage, the ink may not be ejected from the print head and capping may not be performed. In this case, the moisture retaining control is performed before starting the next job in accordance with the flow chart in FIG. 7.

Steps S510 to S517 are a moisture retaining control sequence including ink discharging control described below. Steps S501 to S509 are a determination sequence for determining whether or not the moisture retaining control is necessary. If the moisture retaining control is determined to be necessary, the process shifts to the moisture retaining control sequence. Otherwise the process shifts to a normal sequence.

### (Determination Sequence (steps S501 to S509))

First, in step S501, the apparatus determines whether or not a body cover of the printing apparatus has been opened by the user. If the body cover has not been opened, the process determines that the process shifts to the normal sequence. If the body cover is open, the process shifts to step S502. The body cover is opened by the user in order to replace the ink tank 54 or to remove the print head 10 from the carriage. Whether the body cover is open or closed can be detected using a sensor.

In step S502, the apparatus determines whether or not a voltage Vh for electric conduction to the print head 10 is being applied, that is, whether the voltage Vh is on or off. If the voltage Vh is on, the apparatus determines that the normal sequence is being executed and thus shifts to the normal sequence. If the voltage Vh is off, the apparatus determines that the body cover remains open to prevent the print head 10 from ejecting the ink (non-ink-ejection state). The apparatus thus shifts to step S503. In the non-ink-ejection state, the print head 10 is located at a position where the ink tank 54 can be replaced or a position where the print head 10 can be replaced or has been removed from the carriage 53 by the user.

In step S503, a timer T that measures the time during which the print head fails to eject the ink (non-ink-ejection time) is activated to start counting. In step S504, the apparatus determines whether or not the voltage Vh has been turned on and continues counting the timer T until the voltage Vh is turned on. On the other hand, if the apparatus determines that the voltage Vh has been turned on, the apparatus stops counting of the timer T and stores a count (count time) Ta in the timer T in an EERROM provided in the apparatus main body (step S506). In step S507, the apparatus receives the next job instruction. In step S508, the apparatus references the count Ta stored in the EEPROM to determine whether or not the count Ta indicates at least a predetermined time (in the present example, at least 5 minutes) (step S509). When the count Ta is less than 5 minutes, the process shifts to the normal sequence. When the count Ta is at least 5 minutes, the process shifts to the subsequent part of the moisture retaining control sequence (from step S501 to S509).

### (Moisture Retaining Control Sequence (step S510 to S517)

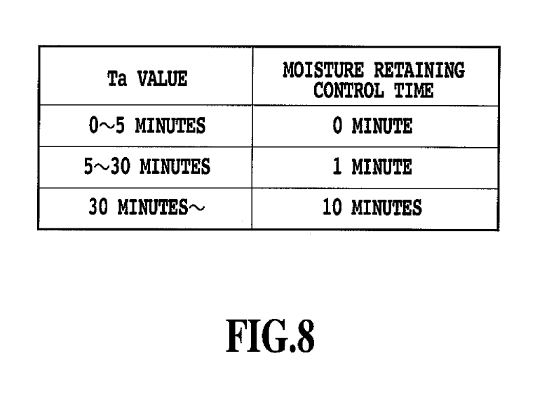

First, in step S510, the carriage 53 is moved to above the cap 60, and the cap 60 is brought into the state of the high sealing level as shown in FIG. 5 in order to collect the ink in the cap 60 (step S511). In the next step S512, the ink is preliminarily ejected from the print head 10 and collected in the cap 60. During the preliminary ejection, for example, a predetermined number of ink drops each of 5 pl are ejected from the print head 10 into the cap 60. In the next step S513, a table in FIG. 8 that associates the count Ta with the moisture retaining control time is referenced to determine the moisture retaining control time corresponding to the count Ta.

In the next step S514, with the cap 60 in tight contact with the print head 10, the moisture retaining control is performed for the moisture retaining control time determined in step S513. That is, the cap 60 with the ink collected therein is contacted with the print head 10 to subject the ejection ports in the print head 10 to moisture retention for the moisture retaining control time. In step S515, the moisture retaining control is ended and the cap 60 is separated from the print head 10.

In the next step S516, a predetermined number of ink drops are preliminarily ejected from each of the ejection ports in the print head 10 to stabilize the state of ink ejection from each ejection port. In the next step S517, the ink collected in the cap 60 is discharged to the exterior (ink discharging control). At this time, as shown in FIG. 6, the absorbent 64 is used to push up the plastic member 63 to bring the cap 60 into the state of the low sealing level. This enables the ink collected in the cap 60 to be discharged from the hole 61A and absorbed and held by the absorbent 64. The moisture retaining control and the ink discharging control are thus finished.

The ink ejecting performance can be maintained by preliminarily ejecting the ink into the cap and subjecting the print head to moisture retention. This is particularly effective for a printing apparatus using a print head adapted to eject small ink drops in a situation in which the ink may not be ejected from the print head and capping may not be performed when the user replaces the ink tank or removes the print head from the carriage. That is, in this situation, performing the moisture retaining control enables the ink ejecting performance of the print head to be maintained. This also eliminates the need for an ink sucking operation of sucking and discharging the ink from the ejection ports in the print head. This in turn enables a reduction in the amount of ink not contributing to image printing and in the volume of the absorbent, which absorbs waste ink.

If the cap 11 comprising the negative pressure generating pump 13 as shown in FIG. 1 is used in place of the cap 60 in the present example, then in the ink discharging control in step S517, the ink in the cap 11 can be discharged to the exterior by operating negative pressure generating pump 13. However, many inexpensive ink jet printing apparatuses are equipped with the cap 11 with the high sealing level but not with the pump 13, which generates negative pressure. The printing apparatus not comprising the pump 13 is able to perform the moisture retaining control on the print head by preliminarily ejecting the ink into the cap 11 but cannot discharge the ink from the cap 11. Thus, if the print head remains capped for a long time, ink colors may be mixed.

Now, description will be given of tests carried out to verify performance achieved when the cap 60 in the present example is set at the high sealing level as shown in FIG. 5 and performance achieved when the cap 60 in the present example is set at the low sealing level as shown in FIG. 6.

### (Verification Tests on Performance at High Sealing Level)

The cap 60 in the present example and the cap 11 were prepared; the negative pressure generating pump 13 was connected to the cap 11 via the tube 12 as shown in FIG. 1. A porous member containing a given amount of moisture was placed in each of the caps 11 and 60, and a cover was placed on a top surface of each of the caps 11 and 60. The caps 11 and 60 were left uncontrolled under conditions including a temperature of 60° C. and a humidity of 15%. Measurement was made of the difference between the initial weight of the moisture-containing porous member and the weight of the porous member after the caps 11 and 60 had been left uncontrolled, to examine a variation in moisture evaporation rate with respect to the time for which the cap had been left uncontrolled.

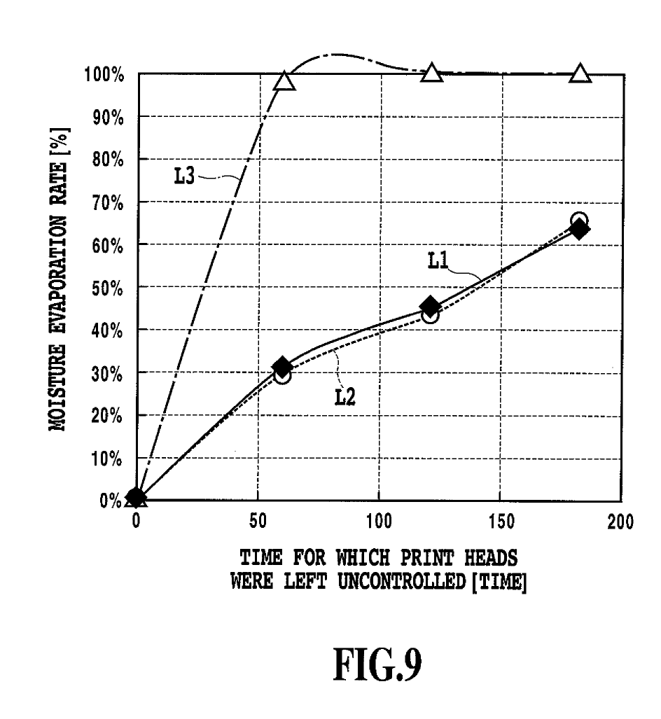

A graph in FIG. 9 shows the results of the tests. In FIG. 9, the axis of abscissa indicates the time for which the cap had been left uncontrolled. The axis of ordinate indicates the moisture evaporation rate determined from the difference between the initial weight of the moisture-containing porous member before the caps were left uncontrolled and the weight of the porous member after the caps were left uncontrolled. In the graph in FIG. 9, a curve L1 composed of a solid line joining black rhombi together indicates the moisture evaporation rate of the cap 11 in FIG. 1. A curve L2 composed of a dotted line joining circles together indicates the moisture evaporation rate of the cap 60 in the present example set at the high sealing level as shown in FIG. 5. A curve L3 composed of a dotted line joining triangles together indicates the moisture evaporation rate of the cap 60 in the present example set at the low sealing level as shown in FIG. 6. The curve L3 indicates that the moisture evaporation rate in the cap reached almost 100% in 50 hours. The two other curves L1 and L2 indicate that even 180 hours later, the moisture evaporation rate was about 60%, that is, the moisture was retained in the cap.

The results indicate that in terms of the moisture evaporation rate with respect to the time for which the caps were left uncontrolled, the cap 60 in the present example set at the high sealing level as shown in FIG. 5 is almost equal to the cap 11 in FIG. 1. The results also indicate that both of the above caps have a higher sealing level than the cap 60 in the present example set at the low sealing level as shown in FIG. 6.

The cap 60 in the present example set at the high sealing rate as shown in FIG. 5 was fitted on each of the print heads with ink ejection amounts of 5 pl, 2 pl, and 1 pl. The print heads were left uncontrolled for three months under conditions including a temperature of 30° C. and a humidity of 15%. Then, 2,000 ink drops were preliminarily ejected from each of the print heads, and the print heads were checked for the ink ejection state. The results are the same as those for the cap 11 in FIG. 1.

Furthermore, as was the case with the experiments described with reference to FIG. 3, the uncapped print heads were left uncontrolled in an environment at a temperature of 30° C. and a humidity of 15% for 5 to 120 minutes. Subsequently, the ink was collected in the cap 60 in the present example set at the high sealing level as shown in FIG. 5. The cap 60 was fitted onto each print head to subject the print head to moisture retention. The moisture retention was maintained for 0 minute, 1 minute, and 10 minutes, and the print heads were checked for the ink ejection state again. As a result, moisture retaining performance similar to that shown in FIG. 4 was confirmed.

The test results indicate the sealing level of the cap 60 in the present example set at the high sealing level as shown in FIG. 5 is as high as that of the cap 11 in FIG. 1. Preliminarily ejecting and collecting the ink in the cap 60 enables the moisture retaining control to be performed.

### (Verification Tests on Performance at Low Sealing Level)

Tests described below were carried out to check discharging performance achieved when the ink collected in the cap 60 in the present example set at the low sealing level as shown in FIG. 6 was discharged.

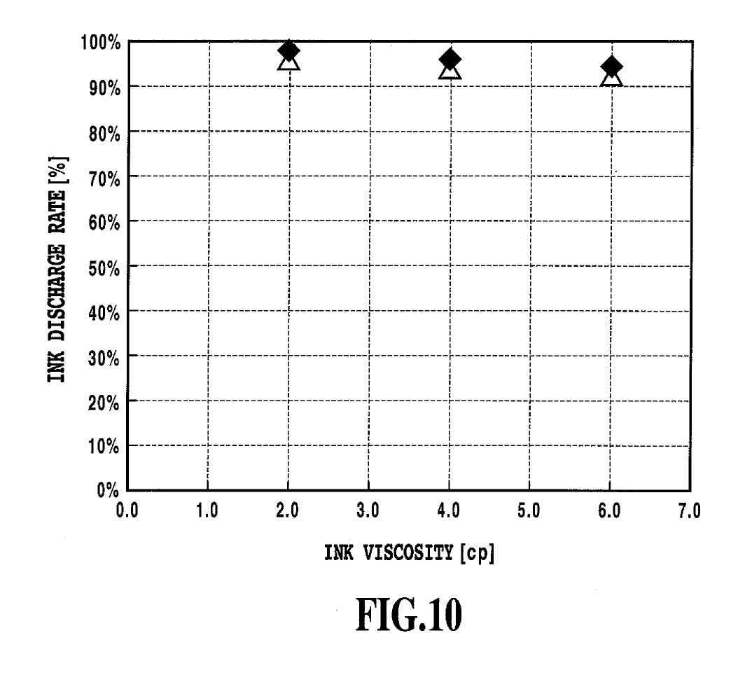

A given amount of ink was collected in the cap 60 in the present example set at the high sealing level as shown in FIG. 5, with the viscosity of the ink varied between 2.0 cp and 4.0 cp and 6.0 cp. Then, an ink discharging operation was performed with the cap 60 set at the low sealing level as shown in FIG. 6. Measurement was made of the difference between the initial weight of the ink collected in the cap 60 before the ink discharging operation and the weight of the ink remaining after the ink discharging operation. Measurement results are shown in a graph in FIG. 10.

In FIG. 10, the axis of abscissa indicates ink viscosity, and the axis of ordinate indicates the ratio of the amount of ink discharged by the ink discharging operation to the initial weight of the ink collected in the cap 60 (hereinafter referred to as the “ink discharge rate”). An increase in ink discharge rate improves the ink discharging performance of the cap. The black rhombi in FIG. 10 denote the ink discharge rate obtained when an idle sucking operation is performed after the ink has been collected in the cap 11 in FIG. 1, to discharge the ink from the cap 11. The idle sucking operation uses the negative pressure generating pump 13 to suck and discharge the ink from the cap 11 separated from the print head 10. Triangles in FIG. 10 indicate the ink discharge rate obtained when the ink discharging operation is performed with the cap 60 in the present example set at the low sealing level as shown in FIG. 6 after the ink has been collected in the cap 60 set at the high sealing level as shown in FIG. 5. The figure indicates that in all the cases, the ink discharge rate is high and about 95% while the ink viscosity is between 2.0 and 6.0 cp.

Ink was collected in the cap 11 in FIG. 1 and then discharged therefrom by the idle sucking operation. Furthermore, ink was collected in the cap 60 in the present example set at the high sealing level as shown in FIG. 5, and the cap 60 was then set at the low sealing level as shown in FIG. 6. The ink discharging operation was performed, and the cap 60 was then set again at the high sealing level as shown in FIG. 5. In a high temperature environment at 40° C., the print heads remain covered with the caps 11 and 60 for three months. Checks were then made of whether or not ink colors were mixed in the print heads. The check results show that possible color mixture was prevented regardless of whichever of the caps 11 and 60 was used as shown in FIG. 11.

The test results indicate that the cap 60 in the present example set at the low sealing level as shown in FIG. 6 exhibits ink discharging performance equivalent to that of the cap 11 in FIG. 1 on which the idle sucking operation is performed to discharge the ink.

Therefore, the cap 60 in the present example can be used to reliably perform the moisture retaining control sequence described above with reference to FIG. 7 and the subsequent controllable discharge of the ink from the cap (step S517). Furthermore, compared to the cap 11, comprising the negative pressure generating pump 13 as shown in FIG. 1, the cap 60 in the present example eliminates the need for a motor serving as an operation source for the negative pressure generating pump 13, or the tube 12, enabling a sharp reduction in manufacturing costs.

### Another Embodiment

In the above embodiments, the cap 60 is configured so that the cap 60 can be switched between two stages corresponding to a closed state and an open state by switchably opening and closing the opening. However, the cap 60 can be configured so that the sealing of the cap 60 can be switched among a plurality of levels.

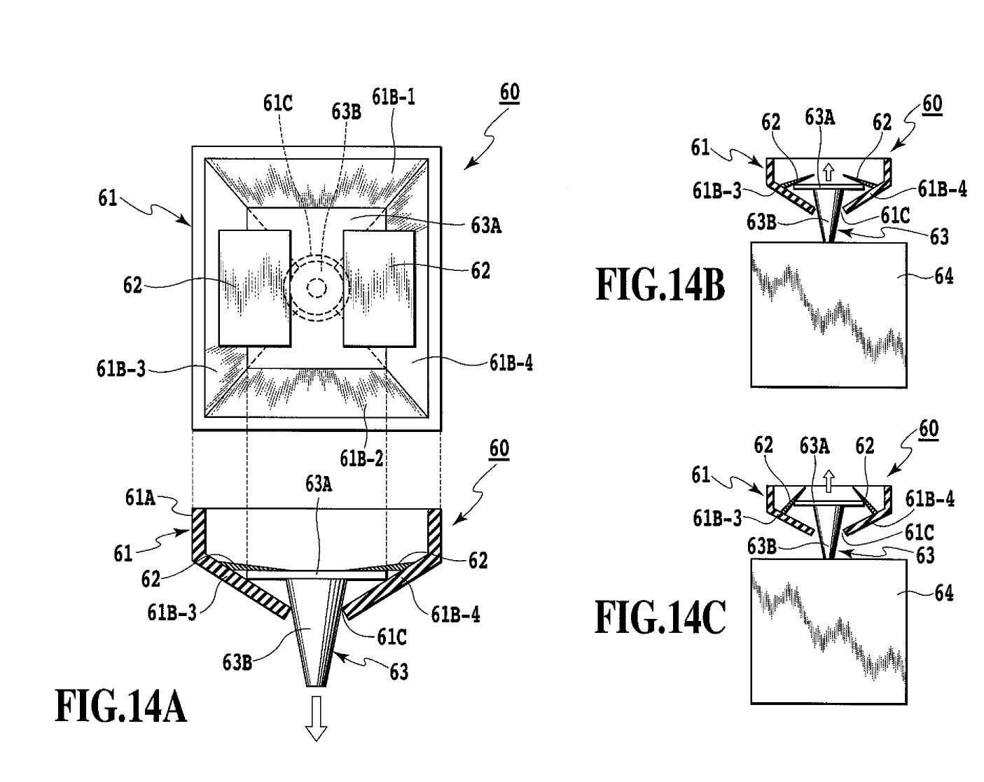

FIGS. 14A, 14B, and 14C are diagrams showing an example of the configuration of the cap 60 that can be switched among the plurality of sealing levels. The cap 60 shown in FIGS. 14, 14B, and 14C is configured so that the area (opening area) in which the interior of the cap contacts the exterior thereof can be switched among a plurality of levels by a column portion 63B as an operation member by switching the pressure contact force of the plate material 63A on the rubber member 62. FIG. 14A is a diagram showing the state of the cap 60 observed when the pressure contact force of the plate material 63A on the rubber member 62 is reduced to avoid providing the opening area. In the state shown in FIG. 14A, a bottom surface-side peripheral portion of the plate material 63A is in tight contact with the four inclined surface portions 61B-1 to 61B-4, allowing the cap 60 to be kept at the highest sealing level. In FIG. 14B, the pressure contact force of the plate material 63A is set higher than that in FIG. 14A to separate the bottom surface-side peripheral portion of the plate material 63A from the four inclined surface portions 61B-1 to 61B-4, allowing the interior of the cap to communicate with the exterior of the cap via the hole 61C. This reduces the sealing level below that in FIG. 14A. FIG. 14C shows that the pressure contact force of the plate material 63A is set higher than that in FIG. 14B. In FIG. 14C, the bottom surface-side peripheral portion of the plate material 63A is located farther from the four inclined surface portions 61B1 to 61B-4 than in FIG. 14B. Consequently, the cap 60 in the state shown in FIG. 14C provides a larger opening area than that in the state shown in FIG. 14B, enabling a further reduction in the sealing level of the cap 60. As described above, the sealing of the cap 60 can be switched among the plurality of levels by allowing the opening area of the opening in the cap 60 to be varied.

Another possible method of switching the sealing of the cap 60 among the plurality of levels is to provide means for varying the gas permeability of the plate material 63A, serving to block the interior of the cap 60 from the exterior thereof. That is, the sealing level can be varied without the need to vary the pressure contact force by providing a plurality of the plate materials 63A with different gas permeability levels and selecting one of the plurality of plate materials 63A for use.

Furthermore, for a moisture retaining control sequence shown from S510 to S517 in FIG. 7, the cap 60 enabling the sealing to be varied among the plurality of levels allows moisture retaining control time to be varied depending on the sealing level of the cap with respect to the same count value Ta. In this case, increasing the sealing level enables a reduction in moisture retaining control time. The cap 60 is thus effective for reducing the moisture retaining control time. Moreover, by performing moisture retaining control on the basis of the combination of the moisture retaining control time and the sealing level of the cap, it is possible to vary the contents of the moisture retaining control depending on the Ta value varying within a range narrower than that observed when only the moisture retaining control time is used. This enables the optimum moisture retaining control to be performed.

The materials of the members 61, 62, and 63, constituting the cap 60, are optional and are not limited to the above embodiments. Any materials may be used provided that the materials makes it possible to provide the function of allowing the cap to tightly contact the print head and the function of opening and closing the hole 61C as an opening to vary the sealing level of the cap. In short, the cap in accordance with the present invention has only to be configured so as to comprise an opening from which the ink inside the cap is discharged to the exterior and an opening and closing mechanism which is able to open and close the opening and which can seal the opening so as to retain the ink in the cap. The opening is desirably formed at a position such that the ink in the cap is discharged through the opening owing to the weight of the ink when the opening is opened by the opening and closing mechanism. The present invention is applicable not only to the ink jet printing apparatus based on the serial scan scheme as is the case with the above embodiments but also to ink jet printing apparatuses based on various other schemes. The present invention is also applicable to, for example, what is called a full line type ink jet printing apparatus, that is, an ink jet printing apparatus using an elongate ink jet print head extending all over the width of a print area on a print target medium.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2006-341392, filed Dec. 19, 2006, which is hereby incorporated by reference herein in its entirety.

What is claimed is:

1. An ink jet printing apparatus printing an image using a print head that is able to eject ink from ejection ports therein and comprising a cap that is able to cap the print head in order to inhibit evaporation of moisture in the ink from the ejection ports,
wherein the cap comprises:
an opening through which the ink inside the cap is discharged to an exterior; and
an opening and closing mechanism which is able to open and close the opening and which is able to close the opening so as to retain the ink in the cap.

2. The ink jet printing apparatus according to claim 1, wherein the opening is formed at a position such that when the opening is opened by the opening and closing mechanism, the ink in the cap is discharged through the opening owing to the weight of the ink.

3. The ink jet printing apparatus according to claim 2, wherein the opening is formed at a bottom portion of the cap.

4. The ink jet printing apparatus according to claim 1, wherein opening and closing mechanism comprises a valve disc that is able to contact and leave a peripheral surface of the opening and an operation member that is able to operate the valve disc from exterior of the cap.

5. The ink jet printing apparatus according to claim 1, further comprising an absorbent that absorbs the ink discharged from the opening of the cap.

6. The ink jet printing apparatus according to claim 1, further comprising a control unit that ejects ink not contributing to image printing from the print head into the cap with the opening closed by the opening and closing mechanism, and then fitting the cap with the opening remaining closed onto the print head.

7. The ink jet printing apparatus according to claim 6, wherein the control unit varies a capping time for which the cap remains fitted on the print head, depending on a time for which the print head fails to eject the ink.

8. The ink jet printing apparatus according to claim 1, wherein the opening and closing mechanism is able to vary the sealing of the cap among a plurality of levels with the opening remaining open.
